(19) United States
(12) Patent Application Publication
(10) Pub. No.: US 2004/0175503 A1
(43) Pub. Date: Sep. 9, 2004

(54) Method for producing thin homogenenous layers with the help of screen printing technology, device for carrying out said method and the use thereof

(76) Inventors: Adolf Bernds, Baiersdorf (DE); Wolfgang Clemens, Puschendorf (DE); Alexander Friedrich Knobloch, Neunkirchen (DE)

Correspondence Address: YOUNG & THOMPSON, 745 SOUTH 23RD STREET 2ND FLOOR, ARLINGTON, VA, 22202

(21) Appl. No.: 10/476,004

(22) PCT Filed: Apr. 15, 2002
(86) PCT No.: PCT/DE02/01400

(30) Foreign Application Priority Data
Apr. 27, 2001 (DE) 101 20 686.0

(51) Int. Cl. B05D 1/32; B05D 5/00

(52) U.S. Cl. 427/256; 427/282; 118/257

(57) ABSTRACT

The invention relates to a method for producing thin homogeneous layers with the help of screen printing technology. According to said method, a low viscosity print medium is applied either continuously or discontinuously to a substrate to be printed by means of a flexible screen belt that is guided on at least two rollers. The invention also relates to a device that is specifically designed for carrying out the inventive method in a preferred embodiment in addition to the use of the method and the device as an integral part of a process for producing polymer electronic components.

### DESCRIPTION

Method for producing thin homogeneous layers with the help of screen printing technology, device for carrying out said method and the use thereof.

The present invention relates to a method for producing thin homogeneous layers with the help of screen printing technology, a special device for carrying out said method as well as the use thereof in the production especially of polymer electronic components. Said method enables the mass production of said components.

In the production of electrical and/or electronic components based on organic materials, one essential aspect is the production of highly homogeneous layers of a low thickness. It is essential to ensure a homogeneous thickness of the layers of an order of magnitude of approximately 10 to 2,000 nm, since the electric functionality depends on this to a significant degree.

To date, organic layers have been produced by means of the so-called spin coating method, a commonly used clean room process. In this method, the substrate to be coated is placed on a rotating table and held in place by means of vacuum suction. Subsequently, a solution of organic materials is applied to the substrate. Subsequent rotation of the rotating table distributes said solution relatively homogeneously across the substrate. The thickness of the layer can be regulated by way of the of table rotation speed and the solids content of the solution. This method produces layers of relatively high quality, with a distinct excess thickness occurring at the edges. It is not possible to achieve a high throughput with this method, since it involves a discontinuous process. In addition, the size of the workable substrate is limited.

A variation of ink jet printing has been proposed as an alternative method. In this method, the ink reservoir of an ink jet printer is filled with the solution of organic materials, which is then printed out like traditional ink. This method, too, only enables a limited speed of production to be achieved and, moreover, the micro drops, which are individually ejected from the ink jet cause a pixelization of the produced layer, thus resulting in non-homogeneity.

A further coating method involves the so-called airbrush method. In this method, the solution of organic materials to be applied is added to an air stream. The coating is effected by means of the solution mist. Due to the individual small solution droplets, this method also does not produce a smooth homogeneous layer.

The screen printing method would be a further technique of applying homogeneous layers to a substrate. This technology is also used in order to print the individual substrates piece by piece. However, in standard screen printing, the substrate must be held in a fixed position for the purpose of printing, which precludes a mass production process in a reasonably economical time period and at a reasonable cost.

In order to establish screen printing as a mass production process, it has been proposed to fabricate the printing form as a rigid cylinder. This is described as rotary screen printing. Rotary screen printing does indeed enable a continuous-feed of the substrate, for instance a foil fed from a roll, thereby permitting a higher rate of throughput. However, this process uses a rigid screen composed of a stable mesh. This results in a high level of stress on the substrate to be printed, so that this system has generally proven to be unsuitable for high precision applications, especially for polymer electronics.

Thus it is a disadvantage of standard screen printing that a mass production process is not possible for economic reasons. The quicker rotary screen printing process is not suitable for high precision applications.

It is therefore the purpose of the present invention to disclose a screen printing method and a device for carrying out said method enabling the production of thin homogeneous layers with a high degree of precision in a cost effective mass production process.

The object of the present invention is a method for producing thin homogeneous layers with the help of screen printing technology, by means of which method a low viscosity print medium is applied either continuously or discontinuously to a substrate to be printed by means of a flexible screen belt that is guided on at least two rollers.

By means of said method, high quality coatings can be produced in a mass production process. According to the inventive method, it is possible to print on all types of substrates, especially flexible substrates such as, for example, foils fed from a roll. Said method is therefore especially well suited to the production of polymer electronic components.

Significant elements of said method are the flexible screen belt, which is preferably a very fine mesh, as well as the use of very low viscosity print media, which enables a uniform and specifically directed distribution of the print medium across the substrate.

For the field of polymer electronics as an area of application, the substrate is defined in particular as a foil of Polyethylene, Polyethylene Therepthalate or a particularly preferred polyimide. The substrate can also already be coated. This is especially the case especially when an entire component is fabricated by means of polymer electronics.

According to the present invention, the print medium preferably has a viscosity of between 1 and 100 mPas. This enables a uniform, low viscosity stream through the screen onto the substrate and thus ultimately the greatest possible homogeneity with a low thickness for the layer of coating.

In relation to the present invention, the print media for this process can comprise standard screen printing inks, photoresists or organic compounds, especially polymer compounds, suspended in a solvent means that is suitable for calibrating viscosity. The choice of solvent means in this connection is largely optional and in most cases depends only on the nature of the print medium.

In particular, this option does not require the development of new substrates and/or print media, but enables the use of materials that are easily accessible under to the present state of technology.

Preferably the solvent means are chosen from among aliphatic or aromatic hydrocarbons with a boiling point equal to or higher than 80° C. This approach makes it possible to avoided additional steps for cleaning of the screen belt, since a drying out of the print medium before, during or after the application to the substrate can largely be precluded.

On the other hand, it is also possible to use solvent means with a boiling point equal to or lower than 80° C., with the application of the print medium in that case, however, being carried out in an atmosphere of the corresponding solvent means, precisely in order to prevent a drying out of the print medium and thus a clogging of the screen belt. For the purpose of specialized applications, this embodiment is also encompassed within the inventive method. The selection of a special solvent means will always depend on the medium to be dissolved, so that this latter embodiment can also be carried out without detracting from the advantages of the inventive method.

The solvent means can exist in pure form or as a mixture of two or more compounds/solvent means.

In a further preferred embodiment, the print medium can be applied to the substrate to be printed in a structured manner or the structuring can be carried out in a subsequent process step. In the case of an already structured application, the flexible screen belt is to be endowed with the desired structuring in advance, This means that in the event that a substrate, or a foil tape respectively, which is to be endowed with a structured coating, is either printed by means of an appropriate structured, flexible screen belt, or that the substrate is prepared in advance in an appropriate fashion, so that the print medium only adheres to the intended areas of the substrate, or that the print medium, having already been applied, is further processed by means of subsequent treatment, such as, for instance, a cross linking step.

Especially in the even that that the inventive method invention is intended for the production of polymer electronic components, the organic polymer compounds that are to be applied to the substrate are likely to be chosen from among non-conducting, semi-conducting and/or conducting polymers.

The preferred conducting polymer compounds in this context are Polyaniline (PANI) or doped Polyethylene (PEDOT). Preferred semi-conduction polymer compounds are conjugated polymers, preferably Polythiophene, Polythienylvinylene or perfluor derivatives. Non-conducting polymer compounds comprise polyhydroxystyrenes or melamine formaldehyde resins containing hydroxyl groups.

An advantage, for the structured coating of a substrate in particular, is the fact that the amount and duration of the application of the print medium can be regulated depending on the desired thickness of the layer to be produced. This, too, is an object of the present invention.

The inventive method is preferably used for the production and/or the build-up of polymer electronics. It is particularly concerned with the build-up of active components of an organic electronic circuit, such as integrated circuits, rectifier diodes, but also with the build-up of passive components of an organic electronic circuit, such as resistors, capacitors, coils.

The device for the application of low viscosity print media to a substrate is characterized by an endless flexible screen belt that is guided on at least two rollers, a print media dispenser, a squeegee mounted immediately after said dispenser in the driving direction of said screen belt, and a counter pressure cylinder mounted below said print medium dispenser and said squeegee for the purpose, in particular, of simultaneously guiding the substrate.

In a preferred embodiment of the device in accordance with the present invention, the amount and duration of the application of the print medium to be fed applied the print medium dispenser can be regulated depending on the desired thickness of the layer to be to be produced on the substrate. All devices known to the present art are suitable for this purpose.

Said device according to the invention may be topped by an apparatus for the thermal treatment of the coated substrate. This relates to a particular embodiment of the present invention, namely if there is to be a structuring of the applied coating. This structuring, too, can be carried out by all methods known to the present art. The apparatus for the thermal treatment can be heating lamps or heated rollers.

According to the invention, the device in accordance with the invention is used as an integral part of a process for producing polymer electronic components. In that case it constitutes one station in an integrated production process.

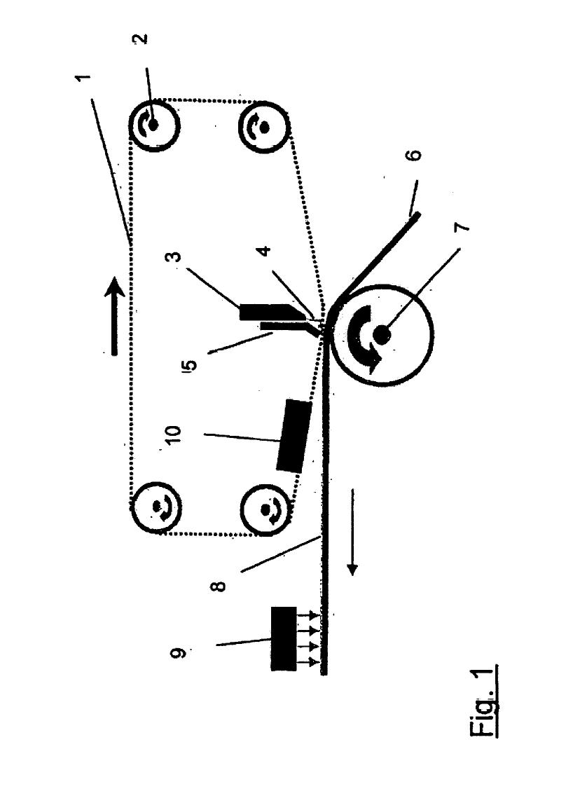

The inventive method is explained below by means of the sole FIG. 1 drawing, which shows the device according to the invention.

Accordingly, said device comprises an endless fine-mesh screen belt (1), which, in the disclosed embodiment, is guided on four rollers (2). Said screen belt (1) moves in a clockwise direction. A print medium dispenser (3) is provided for approximately centrally in the middle, with the print medium (4), in particular the desired polymer solution, being dispensed by said print medium dispenser (3). A squeegee (5) is mounted directly after said print medium dispenser (3), said squeegee (5) pressing said print medium (4) evenly through said screen belt (1). A counter pressure cylinder (7) is mounted below the configuration comprising said print medium dispenser (3) and said squeegee (5), with the substrate (6) moving in between, preferably guided by said counter pressure cylinder (7). Said device is topped by an apparatus (9) for thermal treatment. Said apparatus (9) can be a heating lamp as shown in the present drawing, or it can be implemented by means of heated rollers. After printing, said screen (1) [sic] can additionally be cleaned by a further cleaning member (10) provided in order to prevent an encrusting of said screen belt (1).

Accordingly, a flexible screen, preferably a fine mesh web composed of plastic or fine metal threads, is guided over said rollers (2). Said print medium (4) to be processed, is deposited on said screen (1) from said print medium dispenser (3), with the latter being equipped with a jet (not shown) that is governed by a pneumatic, a piezo or thermal control means. As previously mentioned, said print medium (4) can consist of a traditional screen print ink, a conducting polymer, dissolved in a solvent means, for instance Polyaniline PANI in m-cresol, a non-conducting polymer, dissolved in a solvent means, such as Polyhydroxystyrene PHS or Cymel dissolved in Dioxan or Butanol, or a semi-conducting polymer, dissolved in a solvent means, such as Polyhexylthiophene P3HT in Chloroform, or another medium with a viscosity that is in the range of from 1 mPas to about 1,000 mPas. In the case of quickly evaporating solvent means, that is with boiling points below 80° C., the method must be carried out in a atmosphere of the respective solvent means, since otherwise said print medium (4) will stick to said screen (1). Depending on viscosity, said print medium (4) will remain inert on said mesh [sic] (1), or it will already start to seep through it. At said immediately following squeegee (5), which should be made of hard rubber in order not to damage said fine screen mesh (1), said print medium (4) is applied through said screen (1) to said substrate (6) to be printed. Said substrate (6) can comprise flexible Polyethylene Terephthalate (PET), Polyethylene (PE) or Polymide (PI). In this process, said print medium (4) that has not seeped through said screen (1) is scraped off by means of said squeegee (5). In combination with said print medium dispenser (3), this guarantees a continuous, constant throughput of said print medium (4) through said screen (1), which, in turn, ensures a homogeneous coating. The pressure from said squeegee (5) on said screen (1) is stabilized by said counter pressure cylinder (7), which, at the same time, guides said substrate.

With said device it is possible, depending on the respective specifications, to produce structured or unstructured coatings in a homogeneous manner, with the layers of said coating being of a homogeneous thickness.

1. A method for the production of thin homogeneous layers with the help of screen printing technology in which a low viscosity print medium is applied continuously or discontinuously to a substrate to be printed by means of a flexible screen belt that is guided on at least two rollers.

2. A method according to claim 1, characterized by said print medium having a viscosity from 1 up to 100 mPas.

3. A method according to claim 1 or 2, characterized by said print medium being selected from among screen printing ink, photoresists and/or organic compounds, dissolved in a solvent means, said solving means being suitable for calibrating viscosity.

4. A method according to claim 3, characterized by said solvent means being selected from among aliphatic or aromatic hydrocarbons with a boiling point equal to or higher than 80° C.

5. A method according to claim 3, characterized by solvent means with a boiling point equal to or lower than 80° C. being used in conjunction with the application of the print medium being carried out in an atmosphere of the respective solvent means.

6. A method according to any one of claims 3-5, characterized by said pint medium being applied to said substrate to be printed in a structured manner, or structuring being carried out in a subsequent process step.

7. A method according to claim 3, characterized by said organic polymer compounds being selected from among non-conducting, semi-conducting and/or conducting polymers.

8. A method according to claim 7, characterized by said polymer compound being Polyaniline (PANI) or doped Polyethylene (PEDOT).

9. A method according to claim 7, characterized by said polymer compounds being conjugated polyethylenes, preferably Polythiophene, Polythienylvinylene or perfluor derivatives.

10. A method according to claim 7, characterized by said polymer compound being a polyhydroxystyrene or a melamine formaldehyde resin containing hydroxyl groups.

11. A method as in one of claims 1-10, characterized by the amount and duration of the application of said print medium being able to be regulated depending upon the desired thickness of the layer to be produced.

12. A method as in one of claims 1-11 for the production and/or build-up of polymer electronics.

13. a method as in one of claims 1-22 or 12 for the production of active components of an organic electronic circuit.

14. A method as in one of claims 1-11, 12 or 13 for the production of passive components of an organic electronic circuit.

15. A device for the application of low viscosity print media to a substrate comprising an endless flexible screen belt (1), guided on at least two rollers (2), a print medium dispenser (3) with a squeegee (5) being mounted immediately after said dispenser (3) in the driving direction of said screen belt (1), and a counter pressure cylinder (7) mounted below said print medium dispenser (3) and said squeegee (5) for the purpose of simultaneously guiding said substrate (6).

16. A device according to claim 15, characterized by the amount and duration of the application of said print medium (4) to be applied by means of said print medium dispenser (3) being capable of being regulated depending on the desired thickness of the layer to be produced on said substrate (6).

17. A device according to one of claims 15 or 16, characterized by being topped by an apparatus (9) for the thermal treatment of the covered substrate (8).

18. The use of the device according to claims 15-17 as an integral part of a process for producing polymer electronic components.
